(19) United States
(12) Patent Application Publication
(10) Pub. No.: US 2026/0142838 A1
(43) Pub. Date: May 21, 2026

(54) AUTHENTICATED USER CONTROL OF A BRAIN-COMPUTER INTERFACE

(71) Applicant: Evan SCHNELL, Dover, DE (US)

(72) Inventor: Evan SCHNELL, Dover, DE (US)

(21) Appl. No.: 19/393,393

(22) Filed: Nov. 18, 2025

Related U.S. Application Data
(60) Provisional application No. 63/721,907, filed on Nov. 18, 2024.

(51) Int. Cl. H04L 9/32; G06F 3/01

(52) U.S. Cl. CPC H04L 9/3247; G06F 3/011; H04L 9/3268

(57) ABSTRACT

Methods and systems for using a brain computer interface (BCI) system in a manner to enable only the BCI user to control digital devices or software via the digital motor output (DMO), thereby supporting the BCI user's autonomy by securing private use of a digital device to exclude or control the use of such devices by others.

### CROSS-REFERENCE TO RELATED APPLICATIONS

This application claims the benefit of U.S. Provisional Application No. 63/721,907, filed Nov. 18, 2024, the content of which is incorporated herein by reference in its entirety.

### FIELD OF THE INVENTION

Methods and systems for using a brain computer interface (BCI)system in a manner that enables only the BCI user to control digital devices or software via the digital motor output (DMO), thereby supporting the BCI user's autonomy by securing private use of a digital device to exclude or control the use of such devices by others.

### BACKGROUND OF THE INVENTION

The development of brain-computer-interface (“BCI”) technologies presently focuses both on safety and enabling people living with full or partial paralysis or with limited/decreasing motor ability to use a BCI system to control electronic devices, including prosthetic arms and computers, and to complete a variety of daily tasks. There is a need to restore continuous and independent motor outputs that allow for BCI control of devices by the BCI user. BCI systems hold promise for restoring lost neurologic function, including motor neuroprostheses (MNPs), to restore motor capability to the individual. An implantable MNP can directly infer motor intent by detecting local brain signals and transmitting the motor control signal out of the brain to generate a motor output, referred to as a digital motor output (DMO), and subsequently control computer actions or control other electronic devices. In one variation, this physiological function can be performed by the motor neurons in the individual.

However, while traditional BCI systems provide a paralyzed patient with some level of autonomy through control of the device, the BCI systems that exist today afford only very limited overall autonomy to patients with paralysis. For example, a paralyzed individual using a BCI system typically requires assistance with setting up or turning on the BCI system (including charging/recharging), calibrating the system for an individual's use, including learning how an individual must think so to enable useful electronic commands to be generated; and setting up the individual (adjusting the screens, antennas and/or posture etc. of the patient) to allow the individual to use the system (as opposed to setting up the system itself).

Conventional BCI systems function by connecting with a computing device, such as a computer or tablet. These conventional systems do not enable an individual with limited peripheral mobility to autonomously switch between using a variety of devices. There is a need for individuals with limited peripheral mobility to autonomously control a variety of independent devices at will, both concurrently and to be able to select which devices are controlled at any given time.

There is also a need for a BCI system that provides BCI users with more meaningful autonomy and independence. Such meaningful autonomy and independence can be provided by a BCI system used by an individual that requires less assistance from or even in the absence of a caregiver.

In those cases where a BCI user is using the system due to paralysis or motor impairment, regardless of the extent of paralysis of the BCI user, the BCI user typically requires some assistance from a caregiver to assist the BCI user with their activities of daily living, which means that a caregiver is often in close proximity to the BCI user. This can prevent the BCI user from having privacy since the caregiver is able to see all aspects of the BCI user's digital life, including the BCI user's communications, which may be intended as private or confidential.

Even in a situation with trusting families or caregivers, this lack of privacy is not always ideal. There are risks in that BCI users may not be able to communicate health or medical issues with full candor. More generally, BCI users should have the right and ability to communicate potentially embarrassing topics and other private subject matter to a party of the BCI user's choice without sharing such information with a caregiver or other individuals.

In addition to the concerns above, a BCI user can have challenges with regard to legal agreements, etc. Nonrepudiation, where a user cannot deny (repudiate) having performed a transaction, can also be a significant issue for a BCI user. Nonrepudiation authenticates the identity of a user who performs a transaction and ensures the integrity of that transaction. This invention enables the system to “prove” an action was taken by the BCI user and not another individual who has access to the entirety or parts of the BCI system.

The efficacy of a BCI system can be related to its interoperability with multiple operating environments. Accordingly, a command generated by a DMO initiated by the BCI user can also be generated by a caregiver or someone other than the BCI user if that individual has access to the operating environment. This causes a fundamental risk to the BCI users that, against their will or without their knowledge, another individual can take control of activities that the BCI user intends to control. This can also be a significant problem if a bad actor is able to access the BCI system. Another issue is the inability to maintain the BCI user's privacy, and thus autonomy, when performing basic human activities like communication or information retrieval without the caregiver's knowledge.

If a communication occurs without the BCI user's knowledge and/or approval, a BCI user would not have agency to stop another individual or even the caregiver from accessing the communication or usage history on the digital device. This could impact a user's privacy, safety, and/or sense of autonomy.

As a result, there remains a need for a BCI system to enable each BCI user to communicate with one or more personal host applications (PHA) in a secure manner.

### SUMMARY OF THE INVENTION

Variations of the present disclosure include interface systems for use by an individual to engage an electronic device. In one example such an interface systems includes a neural interface device including one or more components coupled to the individual, where at least one of the one or more components includes a digital signature specific to at least one of the components, where the neural interface device is configured to detect a brain signal from a brain of the individual, to transmit an electronic signal representative of the brain signal, and to transmit the digital signature; a signal control unit that is configured receive and decode the brain signal using one or more algorithms such that it produces a digital motor output signal upon determining that the electronic signal is representative of an intentional neural brain signal generated by the individual; and wherein the signal control unit is further configured to transmit the digital motor output signal and the digital signature to the electronic device to permit the individual to interact with the electronic device.

In addition, variations of the present disclosure also include methods of confirming the use of an interface system by an individual. For example, the methods can include obtaining an electronic signal from the individual using a neural interface device including one or more components coupled to the individual, where the neural interface device is configured to produce the electronic signal by detecting a brain signal from a brain of the individual; transmitting the electronic signal to a processor that is configured receive and decode the electronic signal using one or more algorithms such that the processor produces a digital motor output signal upon determining that the electronic signal is representative of an intentional neural brain signal generated by the individual; and providing a digital signature to an electronic device, where the digital signature is specific to the individual such that the digital signature authenticates use of the electronic device by the individual; and delivering the digital motor output signal to the electronic device to permit the individual to interact with the electronic device.

The systems and methods described herein can include one or more components that are an implanted device configured with the digital signature.

The one or more components can include a neural implant configured for implantation in a brain of the individual, where the neural implant is configured with the digital signature. In addition, the one or more components can include an external component configured with the digital signature.

Variations of the present disclosure include an interface system, wherein the digital signature permits the individual to lock one or more features of the electronic device to prevent access to the one or more features by a third party. The digital signature can include a public key infrastructure digital certificate.

In additional variations, the signal control unit also includes the digital signature. Additionally, the signal control unit can include an additional public key infrastructure digital certificate. The digital signature can be established using an authentication cloud-based service. Alternatively, or in combination, the digital signature can include a cryptographic key.

Variations of the present disclosure include an interface system, wherein the signal control unit includes at least one wireless electronic communication modality for transmitting the digital motor output signal and the digital signature to the electronic device.

While variations of the systems and methods include BCI users who are fully or partially paralyzed or have limited/decreased motor ability, additional variations include any user who could benefit from the systems and methods. For example, such a user could include an individual having motor capabilities but is expected to lose those capabilities due to a chronic condition. Moreover, variations of the systems and methods described herein are used with one or more neuroprostheses with fully implanted recording components. However, additional methods and systems described herein can include partially implanted recording components or external recording components.

The devices, methods, and systems described herein can benefit or be combined with endovascular carriers and electrode arrays and systems/methods of using neural signals disclosed in U.S. Pat. No. 10,575,783 issued on Mar. 3, 2020; U.S. Pat. No. 10,485,968 issued on Nov. 26, 2019; U.S. Pat. No. 10,729,530 issued on Aug. 4, 2020; and U.S. Pat. No. 10,512,555 issued on Dec. 24, 2019. U.S. Publication Nos.: US20190358445 published on Nov. 28, 2019; US20180303595 published on Oct. 25, 2018; US20200352697 published on Nov. 12, 2020; US20190038438 published on Feb. 7, 2019; US20200078195 published on Mar. 12, 2020; US20190336748 published on Nov. 7, 2019; US20200016396 published on Jan. 16, 2020; US20200363869 published on Nov. 19, 2020. U.S. application Ser. No. 17/093,196 filed on Nov. 9, 2020; U.S. application Ser. No. 18/792,965 filed on Aug. 2, 2024; and U.S. application Ser. No. 18/882,591 filed on Sep. 11, 2024. PCT Application Nos.: PCT/US 2020/060780, PCT/US2020/059509, both filed on Nov. 6, 2020. U.S. Provisional application Nos.: 63/003,480 filed on Apr. 1, 2020; 63/057,379 filed on Jul. 28, 2020; and 63/062,633 filed on Aug. 7, 2020. The contents of each of which are incorporated herein by reference in their entirety.

### BRIEF DESCRIPTION OF THE FIGURES

FIG. 1A illustrates an example of an interface system that allows a user to control an electronic device using brain signals.

FIG. 1B illustrates an example of a portable signal control unit having a housing with a user interface on the housing.

FIG. 2 provides a basic illustration of a signal control unit as a central hub for communication with various external devices.

### DETAILED DESCRIPTION

The methods and system described herein provide for an improved BCI system to enable a user to operate the system with more meaningful autonomy and independence. In one variation, a system can enable each BCI user to communicate with each personal host application (PHA) in a secure manner, using secure protocols. Such secure protocols allow the BCI user to communicate with PHAs to the exclusion of a caregiver or any other non BCI user. In additional variations, the user is able to selectively control information or activity that the caregiver is able to access. In an additional variation, the BCI user is able to exclusively communicate with PHAs of choice to the exclusion of a caregiver or any other individual, while enabling a caregiver or any other individual to communicate with other PHAs.

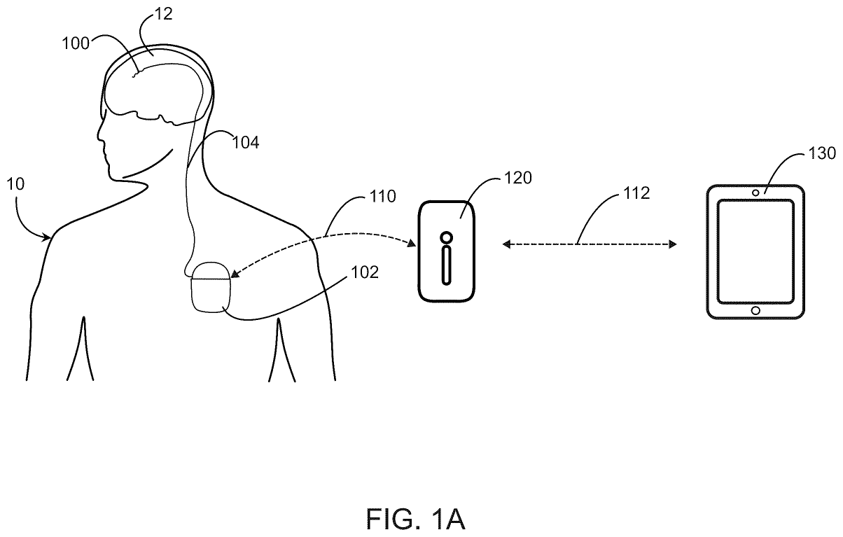

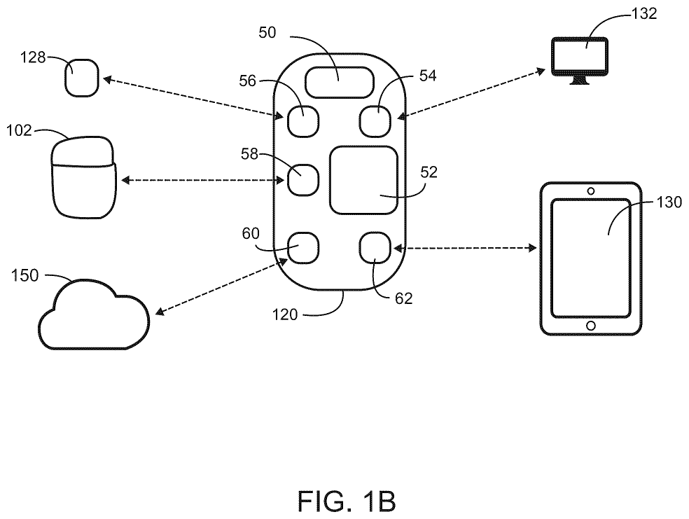

FIG. 1A is a representative illustration of a variation of an interface system that includes a number of components, including an implant 100 positioned within a brain 12 of an individual, a lead 104, and a transmitting unit 102. It is noted that any brain-computer interface is within the scope of this disclosure, including implants that are external to the body, or implants that are directly inserted into brain tissue through an outer layer of tissue. In the illustrated example, the implant 100 can be coupled to a receiver and transmitter unit 102, where the receiver and transmitter unit produce an electronic neural signal from the electrode device corresponding to brain signals from the individual's brain. Typically, the implant 100 is coupled to the receiver and transmitter unit 102 via one or more leads 104. However, this communication can occur wirelessly. Moreover, the systems described herein can be used with various other implantable and non-implantable external devices. In addition, the receiver and transmitter unit 102 can comprise an implantable housing where charging is performed through a capacitive or similar configuration from an external charging unit. Alternate variations include a receiver and transmitter unit 102 that is external to the individual 10.

FIG. 1A also shows the receiver and transmitter unit 102 having an ability to communicate with a signal control unit 120 that receives transmissions from the receiver and transmitter unit 102 and is configured to perform signal processing on the electronic neural signal to perform any number of functions for interaction with a host device 130 or a number of host devices. A host device can comprise any electronic device, such as a computer or tablet, including dedicated and non-dedicated (proprietary and/or non-proprietary) applications. The host device can support secure and proprietary communication with the signal control unit 120 and can provide a user interface for the individual BCI user. In some variations, individuals use the host device 130 to control a wide variety of applications, including.

This signal processing can include filtering, classifying, decoding, and transmitting the data received from the receiver and transmitter unit. In one variation, the inventive system simply comprises a signal control unit 120 and one or more external host devices 130, in which case the signal control unit 120 operates with a variety of systems. One benefit of using a dedicated signal control unit 120 is to provide a signal control unit 120 that allows for a power-efficient, low-latency device for interaction with one or more electronic devices. In addition, the majority of the signal processing and data storage can occur in the signal control unit 120. The signal control unit 120 can be dedicated to signal processing and decision-making with custom applications to guide user interactions. In additional variations, the signal control unit 120 is configured to access a cloud network 150 for computing and storage resources or for analytics. As noted herein, the cloud network 150 can also be used for establishing a digital or unique signature that allows the individual to operate the brain control interface system and prevents others from accessing the system.

Generally, the BCI system (the implant 100 and receiver and transmitter unit 102) captures motor intention from the brain (e.g., the motor cortex) and produces one or more electrical signals corresponding to the motor intention. Electrical signals can be captured from brain activity in regions other than the motor cortex. The signal control unit 120 decodes the electrical signals for utilization with a host device 130 for control of software applications (typically on the host device 130). In some cases, the host device 130 can be used to control additional digital devices (such as a computer, wheelchair, home automation systems, or other devices) that aid the individual 10 using the BCI.

As discussed below, the interface system can include one or more digital signatures that are specific to the individual 10. Such a digital signature can be configured (e.g., through hardware or software) in one of the components of the system (e.g., the implant 100, the lead 104, and/or the transmitter unit 102).

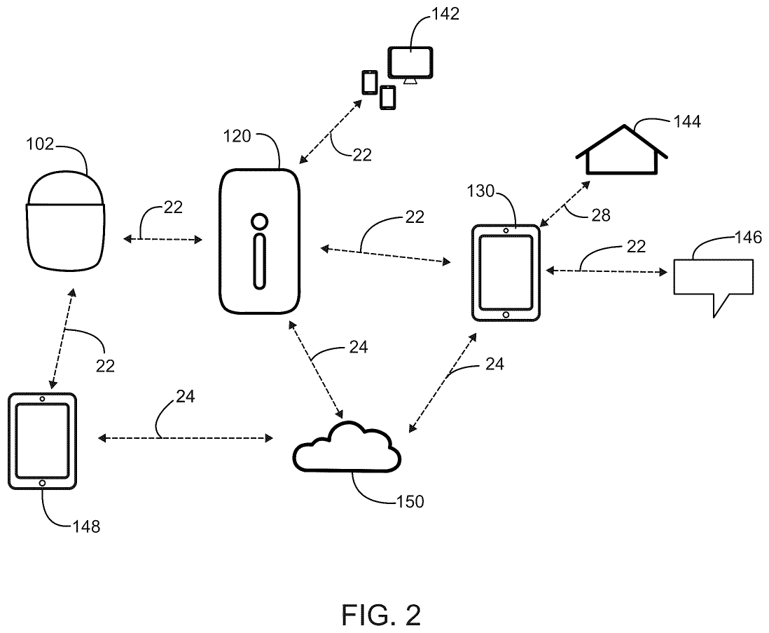

FIG. 2 provides a simplified illustration of an interface system having a signal control unit 120 as a central hub for communication with various external devices using different wireless communication modalities 22, 24. As noted above, signal control unit 120 processes one or more decoding algorithms when receiving information from the receiver and transmitter unit 102. The signal control unit will pass a digital signal from the transmitter unit 102 to ensure that the individual is operating the interface system. Alternatively, or in combination, the individual can use an external device (including but not limited to a smartwatch, personal electronic device, or the signal control unit 120) to provide the digital signature. However, the system offers greater security when the digital signature is provided by an implanted component.

In any case, the information flow can occur via any wireless communication modality, e.g., BLE. However, other transmission protocols, as well as a wired connection, are within the scope of this disclosure. Alternatively, or in combination, a device 148 can communicate directly with the receiver and transmitter unit 102. In such a case, device 148 can house an integrated signal control unit either through hardware or software. In either case, the signal control unit 120 can access a cloud network or infrastructure 150 through WiFi, cellular, or any other network connection means. The ability to access a cloud environment allows for analysis, meta-analysis, generative client/predictive text, the ability to assist patients remotely, and to provide software downloads remotely. A cloud computing and storage component can also allow for aggregation of data and provide management of physicians and data.

In addition, any number of host applications/devices (142, 144, 146) can communicate with the signal control unit 120 either through direct connections 112 (e.g., BLE) or via a network 144 to access a cloud network 150. For example, the host applications can include personal digital devices and/or a monitoring service 142, and the host application can include home automation 144, messaging 146 via text or similar communication modes.

Again, the host devices 130, 148 applications can provide a graphical user interface for the users to calibrate and utilize decoding algorithms to control the host device and to provide Bluetooth HID (Human Interface Device) inputs to BT-enabled devices. In addition, remote monitoring 142 can be used to ensure that the patient and BCI are operating as desired. Furthermore, in case of malfunction, the signal control unit 120 can initiate communications with any external device upon the indication that the BCI or receiver and transmitter unit 102 is not functioning properly.

Widgets within a BCI-specific application are built to specifically not support manipulation by another user with a touch action, keyboard action, or mouse action. In one variation of a BCI system, a digital signature or user ID with each BCI-triggered event prevents any non-BCI user, third party, or any assistive tech in the hands of anyone from acting on the BCI user's behalf. The digital signature is associated with the individual so that the system can confirm that the action taken during operation of the system is occurring through the individual's actions. One embodiment of such a digital/cryptographic signature is a public key infrastructure (PKI) BCI-specific protocol that can manage digital certificates and public-key encryption to prevent unauthorized BCI use. A PKI is a system that uses cryptographic keys and digital certificates to authenticate and secure communications.

PKI-protected BCI-specific protocol can be enabled using a custom application-layer Bluetooth (BLE) encryption scheme that wraps all BCI signal transmissions in mutual authentication and encryption. Every authorized device in the BCI system, such as the recording electrode-laden implant, the receiver and transmitter unit (IRTU) 102, the decoder or signal control unit (SCU), and the PHA, is provisioned with digital certificates, and all communicate over end-to-end encrypted channels with a PKI handshake. This means that even if a malicious actor had a similar tablet or attempted a “man-in-the-middle” attack, such an attempt could not impersonate the BCI user's device - only devices with valid, signed certificates can participate in the BCI control network. The implanted recording device and its companion devices form a cryptographically trusted circle, excluding any third-party inputs, exactly as envisioned.

In alternate variations, encryption and decryption involving the digital signature described herein can be performed according to one or more of any number of encryption algorithms, methods, processes, protocols, and/or standards, including, but not limited to: processes using a public-key infrastructure (PKI), encryption processes using digital certificates, the Data Encryption Standard (DES), the Advanced Encryption Standard (AES 128, AES 192, AES 256, etc.), the Common Scrambling Algorithm (CSA), encryption algorithms supporting Transport Layer Security 1.0, 1.1, and/or 1.2, encryption algorithms supporting the Extended Validation (EV) Certificate, etc. The above examples are intended to be non-limiting, as the systems and methods described herein can use any authentication process.

In one embodiment, the BCI can include an authentication cloud-based service 150 (FIG. 2) that issues a secure and self-contained way to transmit user information between parties, commonly used for authentication and authorization in modern applications, and managing certificate signing for devices. One such authentication service is the JWT-based user tokens, where each BCI user gets a secure digital identity upon logging in. The cloud service issues an authenticated user token, which is passed down to the implant level and cached. This ensures the implant recognizes commands as coming from a verified user. The authentication can be based on user identity or on a device. Using either method, any transaction is non-reputably tied to the BCI user's account.

This private protocol is protected from use by actors without authorized access to the BCI system (e.g., an individual without Synchron implants). A feature or “token” within a BCI system enables only the BCI user to control a DMO, and that cannot be controlled by any other method, whether a mouse click, a screen touch, or a voice-activated command. For example, the token can be a portion of the BCI hardware or software that is unique to the individual using the BCI, such as an implanted component of the BCI, or a secured component or host device used by the individual. This way, the BCI information cannot be taken over, controlled, or observed by unauthorized parties.

The security feature can be similar to a cryptographic or digital signature using a PKI key on the receiver and transmitter unit and/or signal control unit to prove that the DMO came from a brain signal from the individual's receiver and transmitter unit. Use of implanted hardware or software that is unique to the individual can function as a “brain identification” verification that could ensure privacy and/or security for the BCI user. Alternatively or in combination, other biometric information specific to the BCI user can be used for or to supplement the digital signature of the individual to verify authenticity and/or security.

By way of example, this token enables only the BCI user to, by way of example, send a message to a person of the BCI user's choice without any interference or control by another person, and thereby supports autonomy to the BCI user that the BCI user would not otherwise necessarily have.

By way of another example, this token enables only the BCI user to authorize smart-home transactions, such as unlocking a door or making a purchase, purely with BCI-initiated DMOs. Since such PKI-based tokens enable only a BCI user to action DMOs, the BCI's autonomy is enhanced.

A log of the BCI user's commands can be logged to guarantee that no one else could reasonably claim responsibility for the actions of the BCI user.

The exclusive BCI user-enabled token can be activated by a pre-determined “switch” Such a switch can be similar to “lock/unlock” switches such as those described in U.S. Pat. No. 12,461,596, incorporated by reference, that causes the BCI system to accept a DMO only in response to a signal emanating from a receiver and transmitter unit, and therefore, from the BCI user. The token can be applied to only a particular function or activity, such as sending a text message. In this way, the BCI user can concurrently control an activity that s/he does not intend to be interfered with and also have the benefit of a Caregiver's assistance with other activities for which the BCI user does not need exclusive control.

At the software and hardware level, the IRTU 102 can have unique PKI keys. Additional or alternatively, at the software and hardware level, a processor or SCU 120 can have unique PKI keys. The PKI keys in each of the IRTU 102 and the SCU 120 can be inside hardware crypto chips, so they can't be extracted. Additional or alternatively, at the software and hardware level, the recording electrodes and/or the recording head can be cryptographically signed, thereby verifying that the command originates from the implant wearer. The PKI keys in each of the IRTU and/or the SCU 120 and/or other components of the BCI system, through which brain signals or decoded brain signals are transmitted, can be inside hardware crypto chips, so they can't be extricated.

System-level control is also possible. System user interfaces (UIs) can be designed to accept input exclusively from a specific source (the BCI's signal). By way of illustration, the BCI decoder can communicate with an operating system in a trusted exchange so that only the authorized neural signals can execute actions.

At a system level, the security of the BCI-wireless protocol can be enhanced with a closed-loop interface. For instance, Apple's BCI HID profile brings enhanced security and reliability to BCI device control. Since the BCI pairs like a standard HID over encrypted Bluetooth in the iOS environment, the channel of communication between the BCI and the iOS environment is inherently protected and authenticated. Apple's BCI integration is bidirectional in that an iOS device can share screen context back to the BCI's decoder, in real time, thereby creating a closed-loop. This means the system can intelligently adjust decoding of the user's intent based on the UI state at any given time, for example, knowing which app or button is highlighted. For the user, this yields more precise control and reduces false triggers by a person other than the BCI user. The same system-level security can be achieved by the BCI user when communicating with systems other than the iOS environment, such as “Tap to Alexa” that do not recognize the BCI-HID as a native input.

FIG. 1B illustrates a variation of a signal control unit 120 that houses a power supply 50, a processor 52, and circuitry 54-62 to enable wireless and/or wired electronic communication. The power supply 50 can comprise batteries or an external power source. As noted above, the processor 52 is configured to apply one or more algorithms to decode the electronic signal from the transmission component. The signal control unit 120 can also be configured to produce an output signal upon determining that the electronic signal is representative of an intentional neural brain signal generated by the individual. Accordingly, the signal control unit 120 can house any number of communications circuitry or modules 54, 56, 58, 60, and 62 that can be used to electronically communicate with one or more external devices as discussed below. The modules can provide the signal control unit 120 with wireless or wired communication capabilities. Examples of wireless communication include, but are not limited to, short-range wireless (e.g., Bluetooth or Bluetooth low energy), ultra-high frequency (such as low power device 433 MHz), as well as the ability to communicate via an HTTP/HTTPS using a WIFI or other network connection in the variation illustrated in FIG. 1B, the signal control unit 120 can include one or more Bluetooth low energy (BLE) modules to simultaneously or sequentially communicate with the receiver and transmitter unit 120, as well as any number of external devices 130, 132. This wireless connectivity can be a closed-loop system as discussed above. Moreover, the electronic devices, 128, 130, 132, can be configured to only allow control by the user if the digital signature is passed by the system.

Another embodiment of the “BCI user only” control at a system level comprises a situation where the BCI user can cause the PHA and/or the UI, or only certain selected buttons or tiles or other effectors, including those effectors discussed in commonly assigned U.S. patent application Ser. No. 19/338,317, the entirety of which is incorporated by reference. Such effectors can be rendered unresponsive to touch taps or mouse clicks initiated by an able-bodied caregiver or other able-bodied person, thereby disabling such able-bodied person's ability to control the device being used by the BCI user. Alternatively, in the same manner, the BCI user can cause the PHA and/or the UI to be unresponsive to voice control that emanates from a person other than the BCI user. These designs ensure that an able-bodied person cannot simply tap the screen or press a key to interfere with the BCI user's intended actions including DMOs.

The ability of the BCI user to cause the PHA and/or the UI to be unresponsive to inputs other from the BCI user can be activated by a pre-determined “switch” as described in paragraph above.

An advantage of a closed-loop feedback UI is that the HID in a closed-loop system can provide a confirmatory signal to the BCI user, confirming that the user's intended DMO, and not an unintended DMO from a person other than the BCI user, was transmitted to the HID. Such a confirmatory signal can comprise the selected item on the HID being highlighted in a unique manner.

As for other details of the present invention, materials and manufacturing techniques may be employed within the level of those with skill in the relevant art. The same may hold true with respect to method-based aspects of the invention in terms of additional acts that are commonly or logically employed. In addition, though the invention has been described in reference to several examples, optionally incorporating various features, the invention is not to be limited to that which is described or indicated as contemplated with respect to each variation of the invention.

Various changes may be made to the invention described and equivalents (whether recited herein or not included for the sake of some brevity) may be substituted without departing from the true spirit and scope of the invention. Also, any optional feature of the inventive variations may be set forth and claimed independently, or in combination with any one or more of the features described herein. Accordingly, the invention contemplates combinations of various aspects of the embodiments or combinations of the embodiments themselves, where possible. Reference to a singular item includes the possibility that there are plural of the same items present. More specifically, as used herein and in the appended claims, the singular forms “a,” “and,” “said,” and “the” include plural references unless the context clearly dictates otherwise.

It is important to note that where possible, aspects of the various described embodiments, or the embodiments themselves can be combined. Where such combinations are intended to be within the scope of this disclosure.

We claim:

1. An interface system for use by an individual to engage an electronic device, the interface system comprising:
a neural interface device comprising one or more components coupled to the individual, where at least one of the one or more components includes a digital signature specific to at least one of the one or more components, where the neural interface device is configured to detect a brain signal from a brain of the individual, to transmit an electronic signal representative of the brain signal, and to transmit the digital signature;
a signal control unit that is configured receive and decode the brain signal using one or more algorithms such that it produces a digital motor output signal upon determining that the electronic signal is representative of an intentional neural brain signal generated by the individual; and
wherein the signal control unit is further configured to transmit the digital motor output signal and the digital signature to the electronic device to permit the individual to interact with the electronic device.

2. The interface system of claim 1, wherein the one or more components includes an implanted device configured with the digital signature.

3. The interface system of claim 2, where the implanted device is further configured to transmit the electronic signal and the digital signature to the signal control unit.

4. The interface system of claim 1, wherein the one or more components includes a neural implant configured for implantation in a brain of the individual, where the neural implant is configured with the digital signature.

5. The interface system of claim 1, wherein the one or more components includes an external component configured with the digital signature.

6. The interface system of claim 1, wherein the digital signature permits the individual to lock one or more features of the electronic device to prevent access of the one or more features by a third party.

7. The interface system of claim 1, wherein the digital signature comprises a public key infrastructure digital certificate.

8. The interface system of claim 1, wherein the signal control unit also includes the digital signature.

9. The interface system of claim 8, wherein the signal control unit includes an additional public key infrastructure digital certificate.

10. The interface system of claim 1, where the digital signature is established using an authentication cloud-based service.

11. The interface system of claim 1, where the digital signature comprises a cryptographic key.

12. The interface system of claim 1, wherein the signal control unit includes at least one wireless electronic communication modality for transmitting the digital motor output signal and the digital signature to the electronic device.

13. The interface system of claim 12, wherein the at least one wireless electronic communication modality is configured to form a closed-loop interface with the electronic device.

14. A method of confirming use of an interface system by an individual, the method comprising:
obtaining an electronic signal from the individual using a neural interface device comprising one or more components coupled to the individual, where the neural interface device is configured to produce the electronic signal by detecting a brain signal from a brain of the individual;
transmitting the electronic signal to a processor that is configured receive and decode the electronic signal using one or more algorithms such that the processor produces a digital motor output signal upon determining that the electronic signal is representative of an intentional neural brain signal generated by the individual; and
providing a digital signature to an electronic device, where the digital signature is specific to the individual such that the digital signature authenticates use of the electronic device by the individual; and
delivering the digital motor output signal to the electronic device to permit the individual to interact with the electronic device.

15. The method of claim 14, where the neural interface device includes at least one or more components coupled to the individual, wherein the digital signature is provided by one of the one or more components.

16. The method of claim 15, wherein the digital signature is provided by an implanted component of the at least one or more components.

17. The method of claim 16, wherein the implanted component comprises a neural implant configured for implantation in a brain of the individual.

18. The method of claim 15, wherein the digital signature is provided by an external component of the at least one or more components.

19. The method of claim 14, wherein the digital signature permits the individual to lock one or more features of the electronic device to prevent access of the one or more features by a third party.

20. The method of claim 14, wherein the digital signature comprises a public key infrastructure digital certificate.

21. The method of claim 14, where the digital signature is established using an authentication cloud-based service.

22. The method of claim 14, where the digital signature comprises a cryptographic key.

23. The method of claim 14, wherein providing the digital signature to the electronic device and delivering the digital motor output signal to the electronic device is performed wirelessly using a closed-loop interface with the electronic device.

24. The method of claim 14, further comprising providing the individual with an ability to selectively limit one or more features of the electronic device such that the one or more features are not available without the digital signature.

25. The method of claim 24, wherein providing the individual with the ability to selectively limit one or more features of the electronic device comprises limiting the one or more features on a user interface of the electronic device.

26. The method of claim 14, wherein providing the digital signature to the electronic device occurs during each delivery of the digital motor output signal to the electronic device.

27. The method of claim 14, wherein providing the digital signature to the electronic device causes locking or unlocking of the electronic device to control use of the electronic device by another individual.

28. The method of claim 14, wherein providing the digital signature to the electronic device causes locking or unlocking of the electronic device to control use of the electronic device by another individual.
